(19) United States
(12) Patent Application Publication
(10) Pub. No.: US 2025/0085164 A1
(43) Pub. Date: Mar. 13, 2025

(54) WAVELENGTH CALIBRATION METHOD FOR GRATING SPECTROMETERS

(71) Applicants: ZOLIX INSTRUMENTS Co., Ltd., Beijing City (CN); Zolix Analytical Instruments Co., Ltd., Beijing (CN)

(72) Inventors: Zemin Lei, Beijing (CN); Fei Tong, Beijing (CN); Suxia Zhang, Beijing (CN); Haixia Chen, Beijing (CN)

(21) Appl. No.: 18/773,672

(22) Filed: Jul. 16, 2024

(30) Foreign Application Priority Data
Jul. 17, 2023 (CN) 202310873357.X

(51) Int. Cl. G01J 3/02; G01J 3/18; G01J 3/28

(52) U.S. Cl. CPC G01J 3/0297; G01J 3/18; G01J 3/28

(57) ABSTRACT

A wavelength calibration method for a grating spectrometer is provided, including: moving a plurality of characteristic peaks of a calibration light source to a central position of a detector of the spectrometer respectively, and determining a functional relationship between a grating rotation angle of the rotatable grating and a central wavelength; and determining parameters γ, f, a, b, c in the following physical model, the physical model being used to calculate a corresponding wavelength at each pixel within an imaging range of the detector when the central wavelength is determined,

$${λ}^{′} = \frac{sin ( Ψ - \frac{γ}{2} ) + sin ( Ψ + \frac{γ}{2} + arctan ( \frac{{a ( n x )}^{2} + b ( n x ) + c}{f} ) )}{1 {0}^{- 6} \cdot m \cdot N}$$

wherein Ψ is the grating rotation angle corresponding to the central wavelength as determined via the functional relationship, γ is built-in angle of the spectrometer, f is a focal distance of the spectrometer, m is grating diffraction order, N is the number of grating rulings (unit: line/mm), nx is a distance between a corresponding pixel and a central pixel.

### CROSS-REFERENCE TO RELATED APPLICATIONS

This application claims priority to Chinese Patent Application No. 202310873357.X, filed on Jul. 17, 2023, which is hereby incorporated by reference in its entirety.

### TECHNICAL FIELD

The present disclosure generally relates to the technical field of spectrometers, more specifically, to a wavelength calibration method for a spectrometer comprising a rotatable grating.

### BACKGROUND ART

A spectrometer is an instrument for spectral research and spectral analysis of substances, and its basic function is to measure a spectral composition of to-be-studied light, including its wavelength, intensity and profile, etc. The spectrometer usually consists of a light source and illumination system, a collimation system, a dispersion system, an imaging system, and a signal collection system. For the spectrometer, composite light is dispersed into bands via a dispersion element (e.g., a rotatable grating) and is projected onto a CCD detector. Therefore, before using the spectrometer to measure unknown spectral information, a wavelength of the spectrometer needs to be calibrated in advance.

The wavelength calibration of the spectrometer needs use of calibration light sources, the spectrum emitted by the calibration light sources is line spectrum, and a wavelength of its characteristic peak is known, spectrum on the CCD detector is collected, known characteristic peaks are marked, and an appropriate physical model is established by using these characteristic peaks, thereby a wavelength value at any pixel position may be calculated according to the physical model. For a spectrometer with a rotatable grating, a spectrum detected on the CCD detector changes as the grating rotates at an angle, so the established physical model needs to adapt to different angles. Accuracy of wavelength calibration of the spectrometer depends on the number of characteristic peaks of the calibration light sources and the accuracy of a physical model for wavelength calibration of the spectrometer. In a case where the characteristic peaks of the calibration light sources are fixed, a more accurate physical model for wavelength calibration needs to be established.

### SUMMARY

According to the embodiments of the present disclosure, a wavelength calibration method for a spectrometer is provided, the spectrometer comprising a rotatable grating, the method including: by rotating the rotatable grating, moving a plurality of characteristic peaks of a calibration light source to a central position of a detector of the spectrometer respectively, and determining a functional relationship between a grating rotation angle of the rotatable grating and a central wavelength; and by analyzing a plurality of spectrograms obtained under a plurality of central wavelengths, determining parameters γ, f, a, b, c in the following physical model, the physical model being used to calculate a corresponding wavelength at each pixel within an imaging range of the detector when the central wavelength is determined,

$${λ}^{′} = \frac{sin ( Ψ - \frac{γ}{2} ) + sin ( Ψ + \frac{γ}{2} + arc tan ( \frac{{a ( nx )}^{2} + b ( nx ) + c}{f} ) )}{1 {0}^{- 6} \cdot m \cdot N}$$

wherein, Ψ is the grating rotation angle corresponding to the central wavelength as determined via the functional relationship, γ is a built-in angle of the spectrometer, f is a focal distance of the spectrometer, m is a grating diffraction order, N is the number of grating rulings (unit: line/mm), and nx is a distance between a corresponding pixel and a central pixel, and a, b, c are distance optimization parameters.

In some embodiments, determining the functional relationship between a grating rotation angle of the rotatable grating and a central wavelength includes: rotating the rotatable grating at different angles, so as to move a corresponding characteristic peak of the calibration light source to the central position of the detector; and obtaining a corresponding central wavelength and a corresponding grating rotation angle for moving the corresponding characteristic peak to the central position of the detector; and through multiple groups of central wavelengths and grating rotation angles as obtained, performing fitting according to the following linear function to obtain values of parameters k and s,

$$sin ( Ψ ) = k λ + s$$

wherein, λ is the corresponding central wavelength and Ψ is the corresponding grating rotation angle for moving the corresponding characteristic peak to the central position of the detector.

In some embodiments, the fitting is performed via a least square method.

In some embodiments, determining parameters γ, f, a, b, c in the physical model includes: moving a plurality of characteristic peaks of the calibration light source to a central position of the detector respectively via the rotatable grating, and collecting their spectrogram respectively; determining a corresponding grating rotation angle Ψ via a corresponding central wavelength by using the functional relationship; obtaining a wavelength value λ′ and a pixel position nx of a plurality of characteristic peaks in each spectrogram; and through the corresponding grating rotation angle Ψ, the wavelength value λ′ and the pixel position nx of the plurality of characteristic peaks as obtained, performing fitting based on the physical model to obtain the parameters γ, f, a, b, c.

In some embodiments, the fitting is performed via a least square method.

In some embodiments, the rotatable grating is rotated via a stepper motor.

In some embodiments, the calibration light source comprises a light source that emits a line spectrum.

In some embodiments, the light source comprises any one of a mercury lamp, a neon lamp and a krypton lamp.

According to the embodiments of the present disclosure, an apparatus for wavelength calibration of a spectrometer is provided, comprising: a storage, configured to store computer programs; and a processor, coupled to the storage, configured to execute the method of the present disclosure when the computer programs are executed by the processor.

According to the embodiments of the present disclosure, a computer readable storage medium is provided, on which a program code is stored, when the program code is executed by a processor, enabling the processor to execute the method of the present disclosure.

### BRIEF DESCRIPTION OF DRAWINGS

In order to describe technical solutions in the present disclosure more clearly, the drawings required for use in some embodiments of the present disclosure are briefly introduced below. Obviously, the drawings in the following description are only drawings of some embodiments of the present disclosure. Persons skilled in the art may further obtain other drawings based on these drawings. In addition, the drawings in the following description below may be considered schematic diagrams and are not limitations on an actual size of a product, an actual process of a method, an actual timing sequence of signals, etc., to which the embodiments of the present disclosure relate.

FIG. 1 shows an optical path principle diagram of a spectrometer with a rotatable grating according to an embodiment of the present disclosure;

FIG. 2 shows a flow diagram of a wavelength calibration method for a spectrometer according to an embodiment of the present disclosure;

FIG. 3 shows a schematic diagram of a relation between a grating rotation angle and a central wavelength according to an embodiment of the present disclosure;

FIG. 4 shows main characteristic spectral lines and wavelength values of a neon lamp used as a calibration light source according to an embodiment of the present 5 disclosure;

FIG. 5 shows a schematic diagram of the influence of detector plane inclination according to an embodiment of the present disclosure;

FIG. 6 shows a flow diagram of a wavelength calibration method for a spectrometer according to another embodiment of the present disclosure; and

FIG. 7 shows a schematic diagram of peak detection in a dispersion calibration process according to an embodiment of the present disclosure.

The present disclosure will be described with reference to the drawings.

### DETAILED DESCRIPTION

The subject matter described in the present disclosure is now discussed with reference to example embodiments. It should be understood that these embodiments are discussed only to enable persons skilled in the art to better understand and thus realize the subject matter described herein and are not intended to limit a protection scope, applicability or examples expounded in the claims. A change to a function and arrangement of a discussed element may be made without departing from the protection scope of the present disclosure. Each example may omit, replace or add various processes or components as needed. For example, a described method may be executed in a sequence different from a described sequence, and each step may be added, omitted or combined. In addition, features described by some examples may also be combined in others examples.

It should be noted that “one embodiment”, “embodiments”, “some embodiments”, etc., mentioned in the specification indicate that the described embodiment may include a specific feature, structure or characteristic, but not every embodiment includes said specific feature, structure or characteristic. Furthermore, such wordings may not necessarily refer to the same embodiment. In addition, when describing a specific feature, structure or characteristic in conjunction with an embodiment, realization of such feature, structure or characteristic in conjunction with other embodiments which are explicitly or are not explicitly described shall be within knowledge ranges of persons skilled in the relevant fields.

Generally, a term may be understood at least in part according to a context used. For example, at least in part according to a context, the word “one or more” used in the text may be used to describe any feature, structure or characteristic in the singular sense, or may be used to describe a combination of a feature, a structure or a characteristic in the plural sense. Similarly, words such as “an”, “one” or “the” may further be understood to convey singular or plural usage, depending at least in part on a context. Furthermore, the word “based on” may be understood to mean that it is not necessarily intended to convey an exclusive set of factors, but may instead allow for the existence of other factors that may not be explicitly stated, which still depends at least in part on a context.

Embodiments of a wavelength calibration method for a spectrometer according to the present disclosure are now described in conjunction with the drawings.

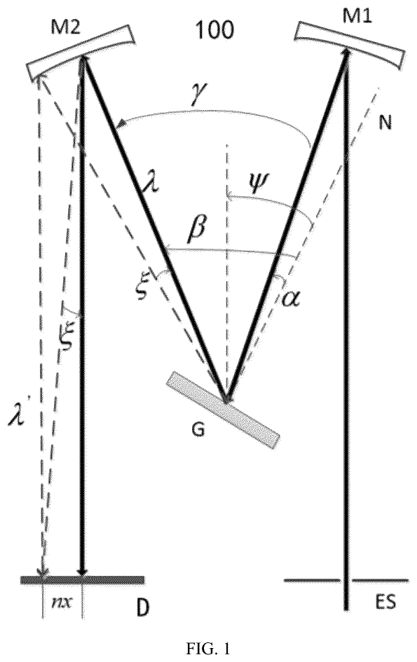

FIG. 1 shows an optical path principle diagram of a spectrometer 100 with a rotatable grating G according to an embodiment of the present disclosure. As shown in FIG. 1, light enters the spectrometer 100 from an incident slit ES, becomes parallel light after being collimated by a reflector M1, and then is incident on a reflection grating G, the grating G has a dispersive effect on the light, and part of the light is reflected by a reflector M2 and converges onto a detector D.

The grating G in the spectrometer 100 is rotatable, and the grating G rotates to different angles, thus spectrums with different ranges may be collected. As shown in FIG. 1, the grating G is rotated by an angle Ψ from a horizontal position to a current position, N is a normal direction of the current position of the grating G, a and B are an incidence angle and a diffraction angle respectively, γ is a built-in angle of the spectrometer, the built-in angle γ and the grating rotation angle Ψ may be calculated by the following formulae.

$$γ = β - α \qquad ( 1 )$$

$$Ψ = α + \frac{γ}{2} = α + \frac{β - α}{2} = \frac{α + β}{2} \qquad ( 2 )$$

In the spectrometer shown in FIG. 1, what converges at the central position of the detector D is a central wavelength, and as can be known from the principle of a grating, a wavelength value λ of the central wavelength at the central position of the detector D also changes during the rotation of the grating G. At the determined central wavelength λ, the detector D (containing n pixels) is capable of collecting a segment of the spectrum including the central wavelength 2, and the wavelength λ corresponding to each pixel in a row direction will be different.

In order to be able to measure unknown spectral information by using the spectrometer 100 shown in FIG. 1, wavelength calibration of the spectrometer 100 is required in advance. That is to say, a physical model that is capable of calculating a corresponding wavelength at each pixel within an imaging range of a detector when a central wavelength is determined needs to be established precisely.

For this purpose, wavelength calibration of a spectrometer with a rotatable grating is required by using a calibration light source. Wavelength calibration of a grating spectrometer generally includes two main steps: central wavelength calibration and dispersion calibration, the basic principle of the two is to use wavelength information of known characteristic peaks of the calibration light source.

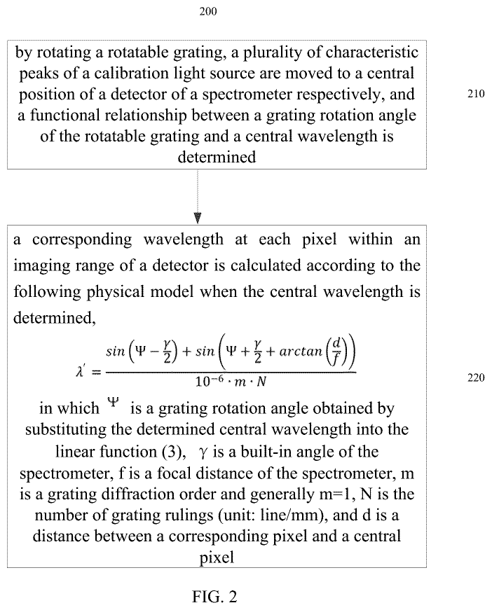

FIG. 2 shows a flow diagram of a wavelength calibration method 200 for a spectrometer according to an embodiment of the present disclosure. It should be understood that the operations shown in the method 200 are not exclusive, and other operations may be performed before, after or between any of the shown operations.

Referring to FIG. 2, the method 200 starts at the operation 210 in which by rotating a rotatable grating, a plurality of characteristic peaks of a calibration light source are moved to a central position of a detector of a spectrometer respectively, and a functional relationship between a grating rotation angle of the rotatable grating and a central wavelength is determined.

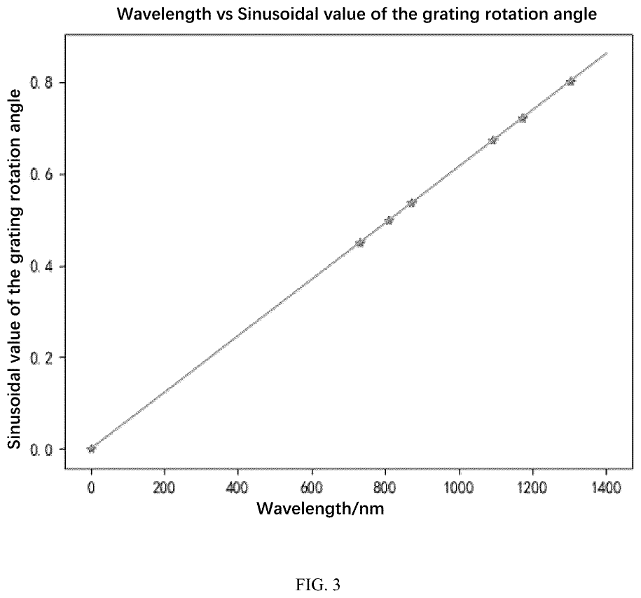

The operation 210 performs central wavelength calibration of the wavelength calibration method 200, that is, determining a functional relationship between the grating rotation angle Ψ of the rotatable grating G of the spectrometer 100 as shown in FIG. 1 and the central wavelength λ. As shown in FIG. 3, a sinusoidal value of the grating rotation angle Ψ has a linear functional relationship with the central wavelength λ.

In one embodiment, determining a functional relationship between the grating rotation angle Ψ of the rotatable grating G of the spectrometer and the central wavelength λ may include: rotating the rotatable grating G at different angles, so as to move a corresponding characteristic peak of a calibration light source to the central position of the detector D; obtaining a corresponding central wavelength λ and a corresponding grating rotation angle Ψ for moving the corresponding characteristic peak to the central position of the detector D; and through multiple groups of central wavelengths λ and grating rotation angles Ψ as obtained, performing fitting according to the following linear function to obtain values of parameters k and s,

$$sin ( Ψ ) = k λ + s \qquad ( 3 )$$

In one embodiment, the fitting may be performed, for example, via a least square method to minimize a deviation of the parameters k and s. In one embodiment, the rotatable grating G may be rotated, for example, via a stepper motor.

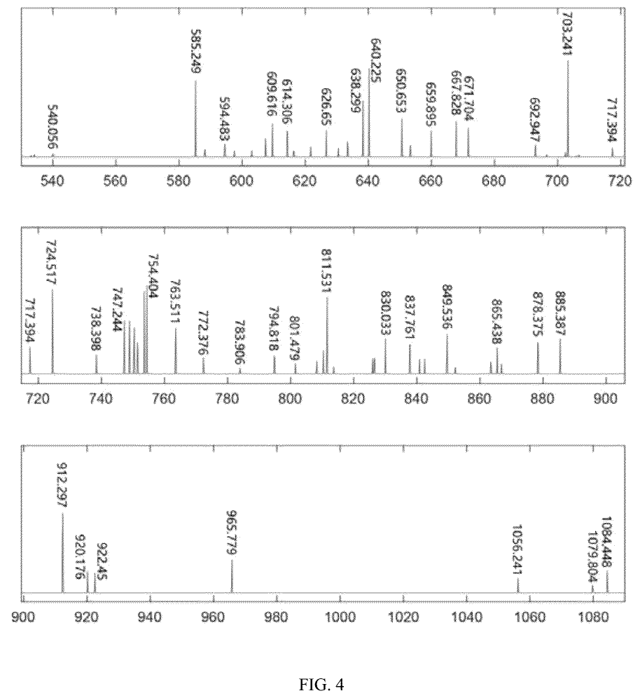

In order to accurately determine the functional relationship between the grating rotation angle Ψ of the rotatable grating G of the spectrometer and the central wavelength λ, within a spectroscopic range of a CCD detector of the spectrometer, the number of characteristic peaks of the calibration light source should be as many as possible and evenly distributed as much as possible. In one embodiment, the calibration light source may comprise a light source that emits a line spectrum, such as any one of a mercury lamp, a neon lamp and a krypton lamp. FIG. 4 shows a main characteristic spectral lines and wavelength values of a neon lamp that may be used as a calibration light source according to an embodiment of the present disclosure.

Next, the method 200 proceeds to the operation 220 in which a corresponding wavelength at each pixel within an imaging range of the detector is calculated according to the following physical model when the central wavelength is determined,

$${λ}^{′} = \frac{sin ( Ψ - \frac{γ}{2} ) + sin ( Ψ + \frac{γ}{2} + arctan ( \frac{d}{f} ) )}{1 {0}^{- 6} \cdot m \cdot N} \qquad ( 4 )$$

where, Ψ is a grating rotation angle obtained by substituting the determined central wavelength into the linear function (3), γ is a built-in angle of the spectrometer, f is a focal distance of the spectrometer, m is a grating diffraction order and generally m=1, N is the number of grating rulings (unit: line/mm), and d is a distance between a corresponding pixel and a central pixel.

The operation 220 performs dispersion calibration of the wavelength calibration method 200. As shown in FIG. 1, light with other wavelength λ′ is projected on non-central positions of the CCD detector, and according to the dispersion principle of the grating, each wavelength has its respective diffraction angle, i.e.,

$${β}^{′} = β + ξ \qquad ( 5 )$$

where, β is a diffraction angle of the central wavelength, ξ is an angle at which the diffraction angle deviates relative to the central wavelength.

Distance d from λ′ to the central wavelength λ, and there is

$$d = n \times x \qquad ( 6 )$$

where, x is a size of a pixel.

According to the geometric relationship shown in FIG. 1, there is

$$tan ( ξ ) = \frac{d}{f} \qquad ( 7 )$$

The following may be obtained through the above formula

$$ξ = arctan ( \frac{d}{f} ) \qquad ( 8 )$$

If the above formula is substituted into a grating equation, there is

$${λ}^{′} = \frac{sin ( a ) + sin ( {β}^{′} )}{1 {0}^{- 6} \cdot m \cdot N} = \frac{sin ( a ) + sin ( β + ξ )}{1 {0}^{- 6} \cdot m \cdot N} = \frac{sin ( Ψ - \frac{γ}{2} ) + sin ( Ψ + \frac{γ}{2} + arctan ( \frac{d}{f} ) )}{1 {0}^{- 6} \cdot m \cdot N} \qquad ( 9 )$$

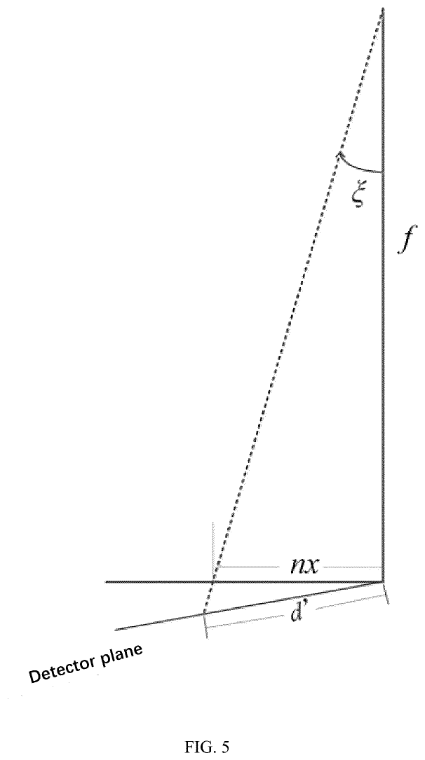

A wavelength value at any pixel position may be determined through such theoretical model. However, as shown in FIG. 1, such theoretical model assumes that the center wavelength light is perpendicular to a photosensitive face of the CCD detector. Actually, it is difficult to reach theoretical verticality, as shown in FIG. 5. In addition, there are gaps between each pixel of an actual CCD detector, and these gaps are also different, and arrangement of multiple pixels in a horizontal direction is not an ideally horizontal. Due to the influence of these factors, wavelength accuracy is not enough by performing wavelength correction of an actual spectrometer using said theoretical model. Therefore, a more accurate physical model for wavelength calibration needs to be established.

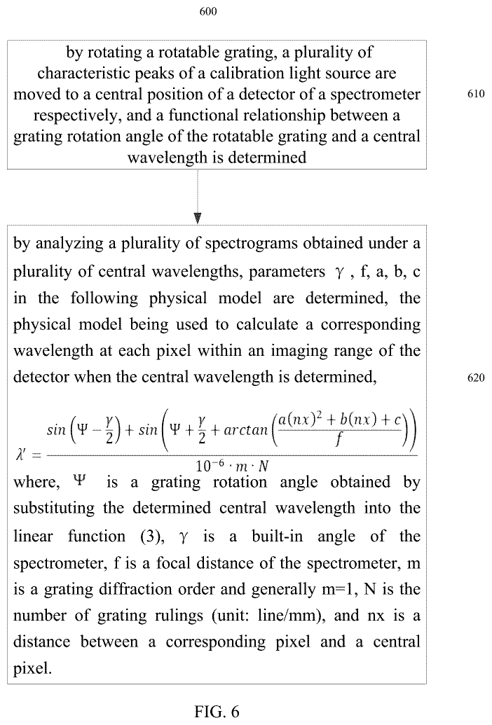

FIG. 6 shows a flow diagram of a wavelength calibration method 600 for a spectrometer in another embodiment of the present disclosure. It should be understood that the operations shown in the method 600 are not exclusive, and other operations may be performed before, after or between any of the shown operations.

Referring to FIG. 6, the method 600 starts at the operation 610 in which by rotating a rotatable grating, a plurality of characteristic peaks of a calibration light source are moved to a central position of a detector of a spectrometer respectively, and a functional relationship between a grating rotation angle of the rotatable grating and a central wavelength is determined. That is to say, the operation 610 for performing central wavelength calibration in the method 600 is the same as the operation 210 in FIG. 2, and is not repeated here.

Next, the method 600 proceeds to the operation 620 in which by analyzing a plurality of spectrograms obtained under a plurality of central wavelengths, parameters γ, f, a, b, c in the following physical model are determined, the physical model being used to calculate a corresponding wavelength at each pixel within an imaging range of the detector when the central wavelength is determined,

$${λ}^{′} = \frac{sin ( Ψ - \frac{γ}{2} ) + sin ( Ψ + \frac{γ}{2} + arctan ( \frac{{a ( n x )}^{2} + b ( n x ) + c}{f} ) )}{1 {0}^{- 6} \cdot m \cdot N} \qquad ( 10 )$$

where, Ψ is a grating rotation angle obtained by substituting the determined central wavelength into the linear function (3), γ is a built-in angle of the spectrometer, f is a focal distance of the spectrometer, m is a grating diffraction order and generally m=1, N is the number of grating rulings (unit: line/mm), and nx is a distance between a corresponding pixel and a central pixel.

Different from the theoretical model shown in Formula (9), in the wavelength calibration physical model shown in Formula (10), a distance between a corresponding pixel and a central pixel is no longer simply expressed as d=n×x, but as:

$${d}^{′} = {a ( n x )}^{2} + b ( n x ) + c \qquad ( 11 )$$

i.e., the original distance d is expressed as a quadratic polynomial, and the influence of a CCD detector inclination angle and a detector pixel gap, etc. are taken into account. Distance optimization parameters a, b and c in Formula (10), the built-in angle γ of the spectrometer and the focal distance f of the spectrometer are variable parameters, which need to be solved via a nonlinear optimization algorithm.

In one embodiment, determining parameters γ, f, a, b, c in a wavelength calibration physical model may include: moving a plurality of characteristic peaks of the calibration light source to a central position of a CCD detector respectively via a rotatable grating G, and collecting their spectrogram respectively; determining a corresponding grating rotation angle Ψ via a corresponding central wavelength by using the linear function (3); obtaining a wavelength value λ′ and a pixel position nx of a plurality of characteristic peaks in each spectrogram; and through the corresponding grating rotation angle Ψ, the wavelength value λ′ and the pixel position nx of the plurality of characteristic peaks as obtained, performing fitting based on the physical model to obtain the parameters γ, f, a, b, c.

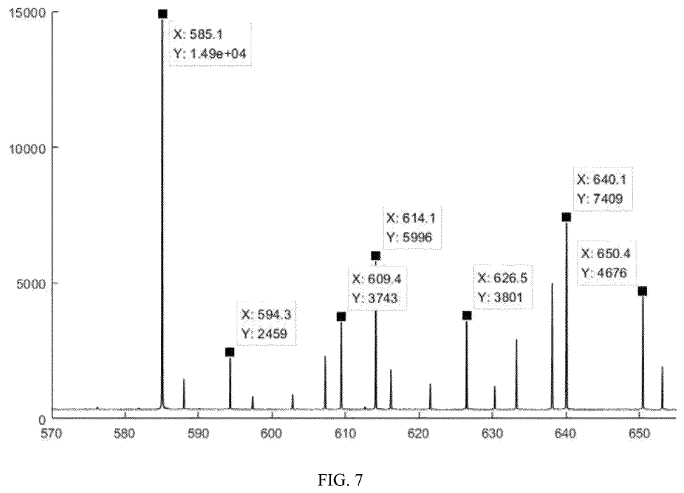

Specifically, the spectrometer is rotated to a central wavelength position, collecting spectrogram is as shown in FIG. 7, characteristic peaks in the spectrogram are analyzed to obtain their wavelength values and pixel positions, i.e., the values of λ′ and nx are obtained. Recording λ′ and nx of all characteristic peaks in the spectrogram can obtain a series of numerical values. In a scannable range of the spectrometer, a plurality of central wavelengths are selected, a plurality of spectrograms corresponding to the plurality of central wavelengths are analyzed, and multiple sets of numerical values of λ′ and nx are obtained. Note that the grating rotation angle Ψ is different at different central wavelengths, and the grating rotation angle Ψ may be determined via the linear function (3). Optimal numerical values of the variable parameters γ, f, a, b, c are calculated by using the obtained multiple grating rotation angles Ψ′ as well as multiple sets of numerical values of λ′ and nx and by using a nonlinear optimization algorithm. A resulting wavelength calibration physical model is capable to be used to calculate a wavelength value in any pixel position at any central wavelength. The variable parameters γ, f, a, b, c in the wavelength calibration physical model are calculated, which completes wavelength calibration of the spectrometer.

In one embodiment, the fitting may be performed, for example, via a least square method to minimize a deviation of the parameters γ, f, a, b, c.

According to the wavelength calibration method for a spectrometer in the embodiments of the present disclosure, for the influence of factors such as detector plane inclination and a non-ideal plane, a wavelength calibration physical model for calculating a corresponding wavelength at each pixel within an imaging range of a detector when a central wavelength is determined is optimized, thereby improving the wavelength calibration accuracy of a grating spectrometer.

According to one embodiment, a computer readable storage medium is provided, on which a program code is stored, when the program code is executed by a processor, enabling the processor to execute various operations and functions in each embodiment of the present disclosure with reference to FIGS. 2-7. Specifically, a system or apparatus configured with a readable storage medium may be provided on which a software program code for implementing functions of any of said embodiments is stored, and a computer or processor of the system or apparatus is enabled to read and execute an instruction stored in the readable storage medium.

Embodiments of the readable storage medium may comprise a floppy disk, a hard disk, a magnetic disk, an optical disk (such as CD-ROM, CD-R, CD-RW, DVD-ROM, DVD-RAM, DVD-RW, DVD-RW), a magnetic tape, a non-volatile memory card, and ROM. Selectively, a program code may be downloaded from a server computer or a cloud via a communication network.

The above description of specific embodiments will fully demonstrate the general nature of the present disclosure, so that others can easily modify and/or adjust various applications of such specific embodiments by applying knowledge within the technical range in the art, without excessive experimentation and without deviating from the general concept of the present disclosure. Therefore, according to the disclosure and guidance given herein, such adjustment and modification are intended to be within the meaning and scope of equivalents of the embodiments disclosed herein. It should be understood that the wording or terms in the present disclosure is for an illustrative purpose and not for limitation, so the wording or terms in the present disclosure will be explained by technical staff according to the disclosure and guidance.

The SUMMARY and the ABSTRACT may expound one or more, but not all, exemplary embodiments of the present disclosure as conceived by the inventor, therefore the SUMMARY and the ABSTRACT are not intended to limit the present disclosure and the accompanying claims by any means.

Width and scope of the present disclosure shall not be limited by any of the above exemplary embodiments, and are defined only according to the accompanying claims and equivalent schemes thereof.

1. A wavelength calibration method for a spectrometer, the spectrometer comprising a rotatable grating, the method comprising:
by rotating the rotatable grating, moving a plurality of characteristic peaks of a calibration light source to a central position of a detector of the spectrometer respectively, and determining a functional relationship between a grating rotation angle of the rotatable grating and a central wavelength; and
by analyzing a plurality of spectrograms obtained under a plurality of central wavelengths, determining parameters γ, f, a, b, c in the following physical model, the physical model being used to calculate a corresponding wavelength at each pixel within an imaging range of the detector when the central wavelength is determined,
$${λ}^{′} = \frac{sin ( Ψ - \frac{γ}{2} ) + sin ( Ψ + \frac{γ}{2} + arctan ( \frac{{a ( n x )}^{2} + b ( n x ) + c}{f} ) )}{1 {0}^{- 6} \cdot m \cdot N}$$
wherein, Ψ is the grating rotation angle corresponding to the central wavelength as determined via the functional relationship, γ is a built-in angle of the spectrometer, f is a focal distance of the spectrometer, m is a grating diffraction order, N is the number of grating rulings (unit: line/mm), nx is a distance between a corresponding pixel and a central pixel, and a, b, c are distance optimization parameters.

2. The method according to claim 1, wherein, determining the functional relationship between a grating rotation angle of the rotatable grating and a central wavelength comprises:
rotating the rotatable grating at different angles, so as to move a corresponding characteristic peak of the calibration light source to the central position of the detector;
obtaining a corresponding central wavelength and a corresponding grating rotation angle for moving the corresponding characteristic peak to the central position of the detector; and
through multiple groups of central wavelengths and grating rotation angles as obtained, performing fitting according to the following linear function to determine parameters k and s,
$$sin ( Ψ ) = k λ + s$$
wherein, λ is the corresponding central wavelength and Ψ is the corresponding grating rotation angle for moving the corresponding characteristic peak to the central position of the detector.

3. The method according to claim 2, wherein, the fitting is performed via a least square method.

4. The method according to claim 1, wherein, determining parameters γ, f, a, b, c in the physical model comprises:
moving a plurality of characteristic peaks of the calibration light source to a central position of the detector respectively via the rotatable grating and collecting spectrograms thereof, respectively;
determining a corresponding grating rotation angle Ψ via a corresponding central wavelength by using the functional relationship;
obtaining a wavelength value λ′ and a pixel position nx of a plurality of characteristic peaks in each of the spectrograms; and
through the corresponding grating rotation angle Ψ, the wavelength value λ′ and the pixel position nx of the plurality of characteristic peaks as obtained, performing fitting based on the physical model to obtain the parameters γ, f, a, b, c.

5. The method according to claim 4, wherein, the fitting is performed via a least square method.

6. The method according to claim 1, wherein, the rotatable grating is rotated via a stepper motor.

7. The method according to claim 1, wherein, the calibration light source comprises a light source that emits a line spectrum.

8. The method according to claim 7, wherein, the light source comprises any one of a mercury lamp, a neon lamp and a krypton lamp.

9. An apparatus for wavelength calibration of a spectrometer, comprising:
a storage, configured to store computer programs; and
a processor, coupled to the storage, when the computer programs are executed by the processor, the processor being configured to execute the method comprising:
by rotating the rotatable grating, moving a plurality of characteristic peaks of a calibration light source to a central position of a detector of the spectrometer respectively, and determining a functional relationship between a grating rotation angle of the rotatable grating and a central wavelength; and
by analyzing a plurality of spectrograms obtained under a plurality of central wavelengths, determining parameters γ, f, a, b, c in the following physical model, the physical model being used to calculate a corresponding wavelength at each pixel within an imaging range of the detector when the central wavelength is determined,
$${λ}^{′} = \frac{sin ( Ψ - \frac{γ}{2} ) + sin ( Ψ + \frac{γ}{2} + arctan ( \frac{{a ( n x )}^{2} + b ( n x ) + c}{f} ) )}{1 {0}^{- 6} \cdot m \cdot N}$$
wherein, Ψ is the grating rotation angle corresponding to the central wavelength as determined via the functional relationship, γ is a built-in angle of the spectrometer, f is a focal distance of the spectrometer, m is a grating diffraction order, N is the number of grating rulings (unit: line/mm), nx is a distance between a corresponding pixel and a central pixel, and a, b, c are distance optimization parameters.

10. The apparatus according to claim 9, wherein, determining the functional relationship between a grating rotation angle of the rotatable grating and a central wavelength comprises:
rotating the rotatable grating at different angles, so as to move a corresponding characteristic peak of the calibration light source to the central position of the detector;
obtaining a corresponding central wavelength and a corresponding grating rotation angle for moving the corresponding characteristic peak to the central position of the detector; and
through multiple groups of central wavelengths and grating rotation angles as obtained, performing fitting according to the following linear function to determine parameters k and s,
$$sin ( Ψ ) = k λ + s$$
wherein, λ is the corresponding central wavelength and Ψ is the corresponding grating rotation angle for moving the corresponding characteristic peak to the central position of the detector.

11. The apparatus according to claim 10, wherein, the fitting is performed via a least square method.

12. The apparatus according to claim 9, wherein, determining parameters γ, f, a, b, c in the physical model comprises:
moving a plurality of characteristic peaks of the calibration light source to a central position of the detector respectively via the rotatable grating and collecting spectrograms thereof, respectively;
determining a corresponding grating rotation angle Ψ via a corresponding central wavelength by using the functional relationship;
obtaining a wavelength value λ′ and a pixel position nx of a plurality of characteristic peaks in each of the spectrograms; and
through the corresponding grating rotation angle Ψ′, the wavelength value λ′ and the pixel position nx of the plurality of characteristic peaks as obtained, performing fitting based on the physical model to obtain the parameters γ, f, a, b, c.

13. The apparatus according to claim 9, wherein, the rotatable grating is rotated via a stepper motor.

14. The apparatus according to claim 9, wherein, the calibration light source comprises a light source that emits a line spectrum.

15. A computer readable storage medium, on which a program code is stored, when the program code is executed by a processor, enabling the processor to execute the method comprising:
by rotating the rotatable grating, moving a plurality of characteristic peaks of a calibration light source to a central position of a detector of the spectrometer respectively, and determining a functional relationship between a grating rotation angle of the rotatable grating and a central wavelength; and
by analyzing a plurality of spectrograms obtained under a plurality of central wavelengths, determining parameters γ, f, a, b, c in the following physical model, the physical model being used to calculate a corresponding wavelength at each pixel within an imaging range of the detector when the central wavelength is determined,
$${λ}^{′} = \frac{sin ( Ψ - \frac{γ}{2} ) + sin ( Ψ + \frac{γ}{2} + arctan ( \frac{{a ( n x )}^{2} + b ( n x ) + c}{f} ) )}{1 {0}^{- 6} \cdot m \cdot N}$$
wherein, Ψ is the grating rotation angle corresponding to the central wavelength as determined via the functional relationship, γ is a built-in angle of the spectrometer, f is a focal distance of the spectrometer, m is a grating diffraction order, N is the number of grating rulings (unit: line/mm), nx is a distance between a corresponding pixel and a central pixel, and a, b, c are distance optimization parameters.

16. The computer readable storage medium according to claim 9, wherein, determining the functional relationship between a grating rotation angle of the rotatable grating and a central wavelength comprises:
rotating the rotatable grating at different angles, so as to move a corresponding characteristic peak of the calibration light source to the central position of the detector;
obtaining a corresponding central wavelength and a corresponding grating rotation angle for moving the corresponding characteristic peak to the central position of the detector; and
through multiple groups of central wavelengths and grating rotation angles as obtained, performing fitting according to the following linear function to determine parameters k and s,
$$sin ( Ψ ) = k λ + s$$
wherein, λ is the corresponding central wavelength and Ψ is the corresponding grating rotation angle for moving the corresponding characteristic peak to the central position of the detector.

17. The computer readable storage medium according to claim 16, wherein, the fitting is performed via a least square method.

18. The computer readable storage medium according to claim 15, wherein, determining parameters γ, f, a, b, c in the physical model comprises:
moving a plurality of characteristic peaks of the calibration light source to a central position of the detector respectively via the rotatable grating and collecting spectrograms thereof, respectively;
determining a corresponding grating rotation angle Ψ via a corresponding central wavelength by using the functional relationship;
obtaining a wavelength value λ′ and a pixel position nx of a plurality of characteristic peaks in each of the spectrograms; and
through the corresponding grating rotation angle Ψ, the wavelength value λ′ and the pixel position nx of the plurality of characteristic peaks as obtained, performing fitting based on the physical model to obtain the parameters γ, f, a, b, c.

19. The computer readable storage medium according to claim 15, wherein, the rotatable grating is rotated via a stepper motor.

20. The computer readable storage medium according to claim 15, wherein, the calibration light source comprises a light source that emits a line spectrum.
Ψγ
